(19) United States
(12) Patent Application Publication
(10) Pub. No.: US 2008/0091427 A1
(43) Pub. Date: Apr. 17, 2008

(54) Hierarchical word indexes used for efficient N-gram storage

(75) Inventor: Jesper Olsen, Helsinki (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/545,491

(22) Filed: Oct. 11, 2006

(51) Int. Cl. G10L 15/04

(52) U.S. Cl. 704/254

(57) ABSTRACT

Systems and methods are provided for compressing data models, for example, N-gram language models used in speech recognition applications. Words in the vocabulary of the language model are assigned to classes of words, for example, by syntactic criteria, semantic criteria, or statistical analysis of an existing language model. After word classes are defined, the follower lists for words in the vocabulary may be stored as hierarchical sets of class indexes and word indexes within each class. Hierarchical word indexes may reduce the storage requirements for the N-gram language model by more efficiently representing multiple words in a single list in the same follower list.

### BACKGROUND

The present disclosure relates to language models, or grammars, such as those used in automatic speech recognition. When a speech recognizer receives speech sounds, the recognizer will analyze the sounds and attempt to identify the corresponding word or sequence of words from the speech recognizer's dictionary. Identifying a word based solely on the sound of the utterance itself (i.e., acoustic modeling), can be exceedingly difficult, given the wide variety of human voice characteristics, the different meanings and contexts that a word may have, and other factors such as background noise or difficulties distinguishing a single word from the words spoken just before or after it.

Accordingly, modern techniques for the recognition of natural language commonly use an N-gram data model that represents probabilities of sequences of words. Specifically, the N-gram model models the probability of a word sequence as a product of the probability of the individual words in the sequence by taking into account the previous N words. Typical values of N are 1, 2, and 3, which will respectively result in a unigram, bigram, and trigram language model. As an example, for a bigram model (N=2), the probability of a word sequence S consisting of three words, W1 W2 W3, in order, is calculated as:

P(S)=P(W1|<S>)*P(W2|W1)*P(W3|W2)*P(</S>|W3)

### In this example, the <S> and </S> symbols represent respectively the beginning and the end of the speech utterance.

Referring briefly to FIG. 1, a block diagram is shown of a section of a basic uncompressed N-gram language model 100. After the language model 100 has been trained, the word list 110 contains every word in the language model 100, and may serve as the dictionary for the language model 100. Each word in the dictionary has an associated set of word followers, or words identified during the training as having some probability of following the word in the dictionary. In this example, the word followers list 120 contains comma-delimited strings identifying a set of likely followers for each word. Thus, based on the training process, the model 100 reflects the fact that the word “your” has some probability of preceding the words “message,” “messages,” or “sister,” in a word sequence. In this example, the probabilities list 130 includes a comma-delimited list corresponding to the words in the word followers list 120. Thus, in this simplified example, there is 0.15 (15%) probability that an occurrence of the word “youth” detected in a word sequence will be immediately followed by the word “camp.” Thus, through determining and storing probabilities of word sequences, the analysis of the acoustical data of an utterance can be supplemented by language model data to more accurately determine the received word sequence.

In N-gram language models, the probabilities for word sequences are typically generated using large amounts of training text. In general, the more training text used to generate the probabilities, the better (and larger) the resulting language model. For bi- and trigram language models, the training text may consist of tens or even hundreds of millions of words, and a resulting language model may easily be several megabytes in size. However, when the memory available to the speech recognizer is limited, restrictions are commonly placed on the size of language model that can be applied. For example, in an embedded device such as a mobile terminal, size restrictions on the language model may result in a smaller dictionary, less word follower choices, and/or less precise probability data. Thus, successful compression of an N-gram language model may result in improved speech recognition applications.

Previous solutions for N-gram language model compression have achieved some measure of success, although there remains a need for additional techniques for language model compression to further improve the performance of speech recognition applications. One previous technique for N-gram language model compression is pruning. Pruning refers to removing zero and very low probability N-grams from the model, thereby reducing the overall size of the model. Another common technique is clustering. In clustering, a fixed number of word classes are identified, and N-gram probabilities are shared between all the words in the class. For example, a class may be defined as the weekdays Monday though Friday, and only one set of follower words and probabilities would be stored for the class.

Yet another technique for compressing N-gram language models is quantization. In quantization, the probabilities themselves are not stored as direct representations (like the probability list 130 of FIG. 1), but are instead represented by an index to a codebook of probability values. Less space is required to store the language model because storing the codebook index requires less memory than storing the probability directly. For example, if direct representation requires 32 bits (the size of a C float), then the storage for the probability itself is reduced to a fourth if an 8-bit index to a 256 element codebook is used to represent the probability.

Referring now to FIG. 2, a block diagram is shown representing a storage structure 200 corresponding to an N-gram model, which uses some of the above-discussed conventional techniques for language model compression. In structure 200, the vocabulary of words in the model (e.g., 211-218) are stored as word identifiers that reference a word dictionary for the speech recognizer. Additionally, for each word identifier 211-218, a set of possible word followers 221-228 is stored. Each possible word follower in the sets 221-228 is also stored as a word identifier referencing the word dictionary. Of course, the probabilities associated with each stored possible word follower may also be stored (not shown). As shown in FIG. 2, certain words may have very few word followers, e.g., word_id2 212 and word_id8 218, possibly indicating that during the training process those words repeatedly preceded a same small common set of follower words. Other words in the structure 200, e.g., word_id 211, have many associated bigrams (i.e., many word followers), perhaps indicating that those words preceded many different following words in the training text. Alternatively, depending on the training process used, certain words in the vocabulary may have no follower words.

The following practical example illustrates the storage requirements for using of the compression techniques of FIG. 2. An N-gram language model developed for natural language dictation of spoken messages may have a vocabulary of 38,900 words (unigrams). After the training process, the language model may have identified 443,248 bigrams (i.e., 2-word sequences). Thus, in this example, each word in the storage structure 200 has an average 11.4 follower words (443,248/38,900). Since the number of words in the vocabulary is less than 65,535, each word identifier may be represented using a 16-bit index to a word dictionary. Storage for this data structure 200 can be determined by the following equation:

38900 words*11.4 followers/word*2 bytes/follower=886,920 bytes

### Thus, any device running the speech recognizer in this example must dedicate approximately 866 kilobytes (KB) to storing this bigram language model.

Accordingly, there remains a need for systems and methods for compressing N-gram language models for speech recognition and related applications.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

According to one aspect of the present disclosure, a data model, such as an N-gram language model used in speech recognition applications may be compressed to reduce the storage requirements of the speech recognizer and/or to allow larger language models to reside on devices with less memory. In creating a compressed N-gram language model, the words in the vocabulary of the model are initially identified through a training process. These words are then assigned into word classes based on the relationship between the words, and the likelihood that certain groups of words are followers for other words in the vocabulary. After word classes are defined, the follower lists for words in the vocabulary may be stored as hierarchical sets of class indexes and word indexes within each class, rather than using larger word identifiers to uniquely identify the word across the entire vocabulary. In other words, using hierarchical word indexes may reduce the storage requirements for the N-gram language model by more efficiently representing words in follower lists using hierarchical class indexes and word indexes.

According to another aspect of the present disclosure, the words in the vocabulary may be assigned to word classes based on a predetermined syntactic or semantic criteria. For example, words may be assigned into syntactic classes based on their parts of speech in a language (e.g., adjective, nouns, adverbs, etc.), or into semantic classes based on related subjects. In other examples, a statistical analysis of an existing language model or the training text used to create the language model may be used to determine the word class assignments. In these and other examples, words classes are preferably assigned based on the likelihood that the words in the same class will be found in the same follower lists for other words in the vocabulary.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram showing a section of an uncompressed N-gram language model, in accordance with conventional techniques;

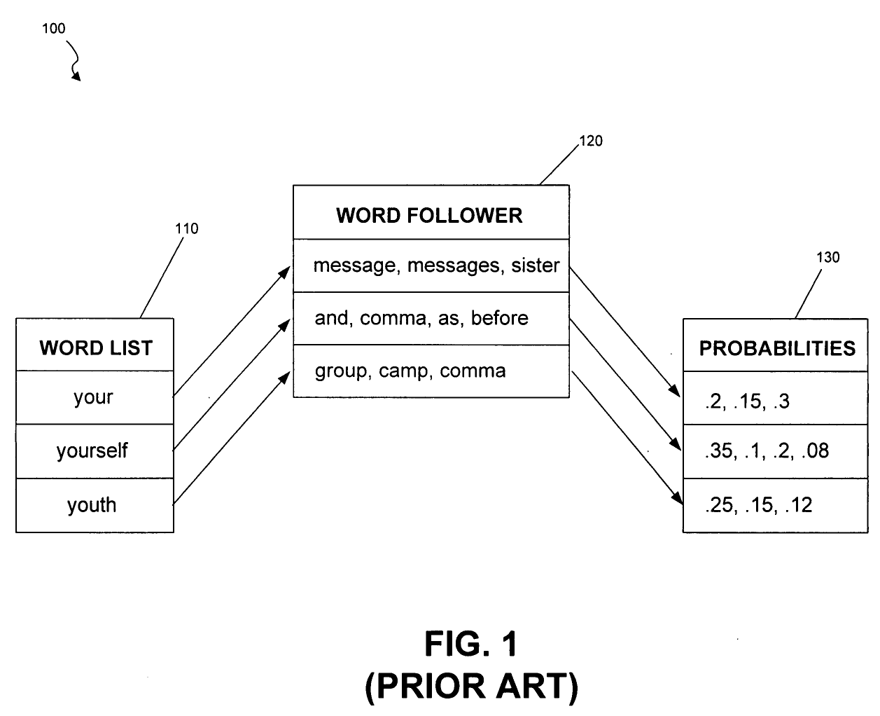

FIG. 2 is a block diagram representing a storage structure corresponding to an N-gram model, in accordance with conventional techniques;

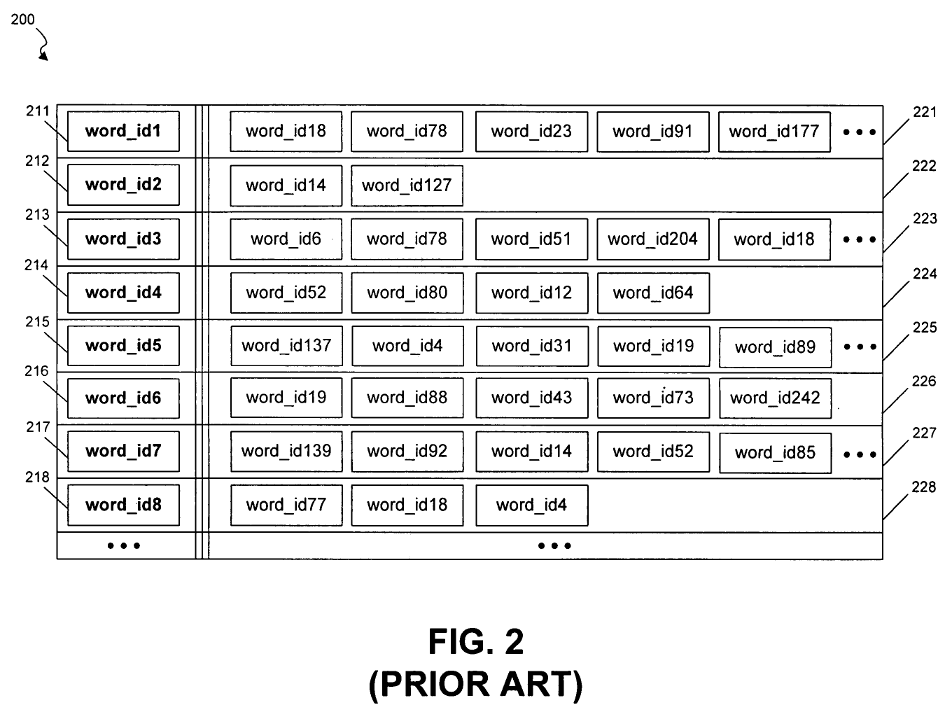

FIG. 3 is a block diagram illustrating a computing device, in accordance with aspects of the present invention;

FIG. 4 is a flow diagram showing illustrative steps for creating a storage structure corresponding to an N-gram model, in accordance with aspects of the present invention;

FIG. 5 is a block diagram representing an illustrative storage structure corresponding to an N-gram model, in accordance with aspects of the present invention;

FIG. 6 is a flow diagram showing illustrative steps for retrieving of a set of follower words from an N-gram model, in accordance with aspects of the present invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

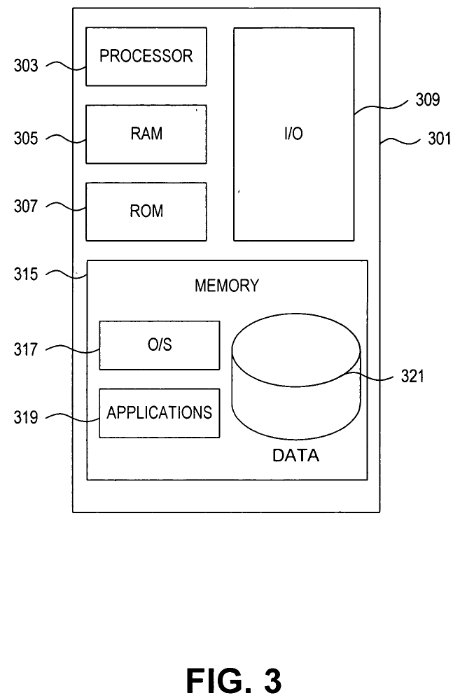

FIG. 3 illustrates a block diagram of a generic computing device 301 that may be used according to an illustrative embodiment of the invention. Device 301 may have a processor 303 for controlling overall operation of the computing device and its associated components, including RAM 305, ROM 307, input/output module 309, and memory 315.

I/O 309 may include a microphone, keypad, touch screen, and/or stylus through which a user of device 301 may provide input, and may also include one or more of a speaker for providing audio output and a video display device for providing textual, audiovisual and/or graphical output.

Memory 315 may store software used by device 301, such as an operating system 317, application programs 319, and associated data 321. For example, one application program 319 used by device 301 according to an illustrative embodiment of the invention may include computer executable instructions for invoking user functionality related to communication, such as email, short message service (SMS), and voice input and speech recognition applications.

Device 301 may also be a mobile terminal including various other components, such as a battery, speaker, and antennas (not shown). I/O 309 may include a user interface including such physical components as a voice interface, one or more arrow keys, joy-stick, data glove, mouse, roller ball, touch screen, or the like. In this example, the memory 315 of mobile device 301 may be implemented with any combination of read only memory modules or random access memory modules, optionally including both volatile and nonvolatile memory and optionally being detachable. Software may be stored within memory 315 and/or storage to provide instructions to processor 303 for enabling mobile terminal 301 to perform various functions. Alternatively, some or all of mobile terminal 301 computer executable instructions may be embodied in hardware or firmware (not shown).

Additionally, a mobile terminal 301 may be configured to send and receive transmissions through various device components, such as an FM/AM radio receiver, wireless local area network (WLAN) transceiver, and telecommunications transceiver (not shown). In one aspect of the invention, mobile terminal 301 may receive radio data stream (RDS) messages. Mobile terminal 301 may be equipped with other receivers/transceivers, e.g., one or more of a Digital Audio Broadcasting (DAB) receiver, a Digital Radio Mondiale (DRM) receiver, a Forward Link Only (FLO) receiver, a Digital Multimedia Broadcasting (DMB) receiver, etc. Hardware may be combined to provide a single receiver that receives and interprets multiple formats and transmission standards, as desired. That is, each receiver in a mobile terminal 301 may share parts or subassemblies with one or more other receivers in the mobile terminal device, or each receiver may be an independent subassembly.

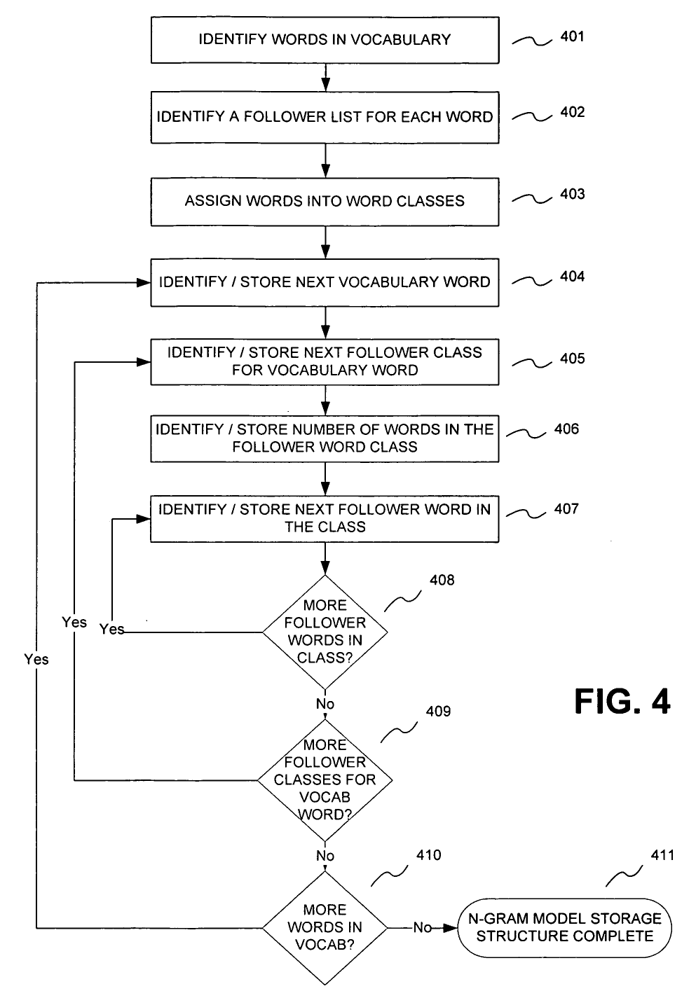

Referring to FIG. 4, a flow diagram is shown illustrating the creation of a storage structure corresponding to an N-gram language model in accordance with aspects of the present invention. In step 401, the vocabulary for the language model (i.e., the same set of words that will be represented in the dictionary of the speech recognizer) is identified. The set of words in the vocabulary may be determined using a training process as described above, and as is well known in the art. Potentially every word, number, punctuation mark, or other symbol may be included as a “word” in the vocabulary. Alternatively, certain symbols, punctuation, or certain small and common words, may be excluded from the vocabulary. Thus, while the present disclosure refers to “words” and uses many word sequence examples from the English language, it should be understood that a “word” is not limited as such. The inventive concepts described herein may be applicable to other spoken or written languages. Additionally, as another example, the vocabulary of the language model may consist of numbers, where the language model is used by a processor designed to analyze, interpret, and predict number sequences.

In step 402, for at least a subset of the words in the vocabulary, a follower list is identified. As described above, the follower list may include one or more other words that may succeed the word in a speech word sequence. A vocabulary word may have a follower list with only one word, a few words, a large number of words, or even no words at all. The follower list for a word will depend on the particular training process used and the training text selected. Similarly, each word in the follower list may have an associated probability, which may be implemented as a weighting factor, representing a likelihood that word will be succeeded by that follower word.

In step 403, the words in the vocabulary are assigned to different word classes based on relevant characteristics of the words. The defining of word classes and assignment of the words into their respective classes may be based on the likelihood that the words in a class will be found in the same follower lists for other words in the vocabulary. To illustrate, using the above-discussed example, the weekday words (“Monday”, “Tuesday”, “Wednesday”, “Thursday”, “Friday”) may be placed in the same word class based on a determination, or a predetermined assumption, that they will likely be in the same follower lists for other words in the vocabulary (e.g., “every”, “next”, “this”). It is also possible for a word to be a member of multiple classes. Thus, although clustering was discussed as a conventional method, the assignment of word classes in step 403 does not cluster words for the purpose of sharing a follower list between the words. The significance of this distinction is discussed in detail below.

After assigning the words into different word classes, an alternative technique is available for identifying a unique word in the vocabulary. Rather than using a single word identifier, as described above, a word may be referenced by a combination of a first index corresponding to the word class, and a second index corresponding to the word within the class. Thus, assigning words into word classes in step 403 may effectively create a hierarchical word index. Additionally, since it is permissible for a word to be a member of more than one class, there may be multiple class index/word index combinations that are associated with the same word in the speech recognizer's dictionary. There is no inconsistency caused by assigning words to multiple classes, as long as each combination of a class index and a word index within that class may be resolved into a single unique word in the dictionary.

Additional advantages may be realized if the words are assigned into a maximum of 256 word classes, and if each word class contains a maximum of 256 words. If the word classes are so assigned, then 8-bit storage locations may be used to store the class indexes and the word indexes corresponding to the words within each class.

Many various implementations are available for defining the word classes and assigning words from the vocabulary into different classes. Syntactic classes, for example, group words into classes based on a predetermined syntax for the language being modeled. For instance, part of speech (POS) syntactic classes may assign words into classes such as Nouns, Verbs, Adverbs, etc. Alternatively, class modeling based on semantic word classifications may be used when assigning words into word classes. For example, in certain speech recognition contexts, words that express similar or related ideas (e.g., times, foods, people, locations, animals, etc.) may be assigned to the same class. Thus, in these examples, the assignment of word classes is based on predetermined class criteria (e.g., POS or content).

Word classes may also be assigned based on a statistical clustering analysis of an existing language model or training text. After performing a conventional N-gram language model training process, the resulting storage structure may already have the word identifiers and follower lists for each word in the vocabulary. A statistical analysis on the conventional storage structure may be used to determine which of the possible word assignments will result in classes with members that are frequently found in the same follower lists for other words. Additionally, when the speech recognizer determines class assignments by analyzing existing language models, it may dynamically adjust the applied class criteria as needed to ensure that the class assignments are appropriate. To illustrate, if predetermined POS criteria are used for class assignments, then, depending on the training text, there is a possibility that one POS word class may end up with more then 256 words, while other classes have far fewer words. However, when analyzing an existing language model, the class criteria may be customized to that model so that no class will be overfilled. Similarly, using analysis, class assignments may be adjusted by comparing different possible assignments and determining which assignments are preferable (e.g., which class assignments result in the most occurrences of class members residing together in the same follower lists).

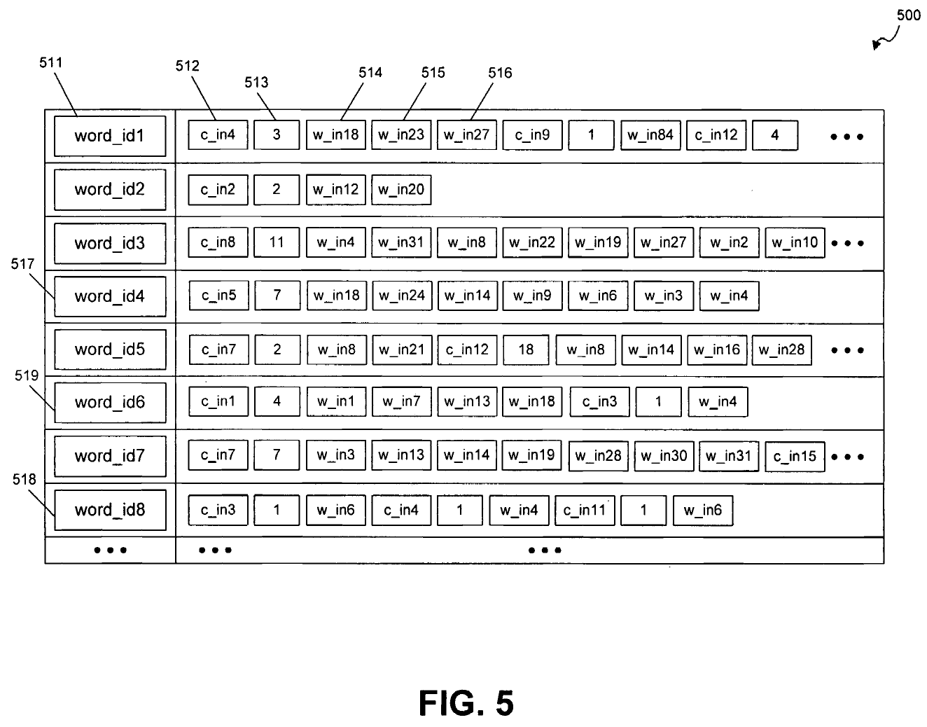

Beginning in step 404, after the vocabulary, follower lists, and word classes have been determined, a data structure storing this information may be created. In order to illustrate this process, the steps 404-411 will also be discussed in reference to the storage structure 500 of FIG. 5. Of course, illustrative data structure 500 is only one possible way of storing the relevant data obtained in steps 401-403. Thus, while a simple approach to storing word identifiers may be a 2-dimensional array of unsigned integers of various sizes, as shown in FIG. 5, many other possible data structures and data types well known in the art may be used.

In step 404, a word identifier 511 (word_id1) corresponding to the first (or next) word in the vocabulary is stored in the storage structure 500. A word identifier may be, for example, an 8-bit or 16-bit integer, depending on the dictionary size, so that every word in the dictionary may be assigned a unique word identifier.

In step 405, the follower list for the first word 511 is traversed and a first class index value 512 corresponding to at least one word in the follower list is identified. The class index value 512 (c_in4) is stored in the structure 500. As discussed previously, since there are fewer word classes than overall words in the vocabulary, the class index value 512 may require less storage space than a conventional word identifier. For example, in a vocabulary consisting of 65,000 words, a 16-bit value is required for unique word identifier. However, if the words are assigned into 256 (or less) different word classes, than the unique class index may be stored as an 8-bit value.

In step 406, the follower list for the word 511 is reviewed to determine how many follower words are assigned to the class corresponding to the class index value 512. As previously discussed, classes may be assigned based on the likelihood that multiple words from a class will be found in the same follower list for other words in the vocabulary. Thus, as shown in FIG. 5, it is likely that multiple words in the follower list of the word 511 will have the same class index value 512. After determining the number of followers with class index value 512, this value 513 (3) is stored in the structure 500.

In steps 407 and 408, the word index values 514-516 for the words in the follower list having class index value 512 are stored in the structure 500. As discussed above, the word index values need not be unique identifiers within the entire vocabulary, as long as each word index is unique within its class. Thus, both the class index 512 and the word index 514-516 might be needed to identify the referenced follower word. Advantageously, since there are fewer words in a class than in the entire vocabulary, the word index values 514-516 may require less storage space than a conventional word identifier. For example, if no class has more than 256 words, than an 8-bit value may be used to store each word index, rather than a 16-bit value commonly used for a word identifier. As mentioned above, each follower in a word's follower list may have an associated probability representing the likelihood that the word will be succeeded by that follower. Thus, a probability value may be associated with each word index in the storage structure 500. Although not shown in FIG. 5, these probability values may be stored in same storage structure as the class and word index hierarchy, for example, in the same row of the 2-dimensional array immediately after each word index. These probability values may directly represent the probabilities themselves (e.g., as a float value embedded into the structure), or may be indexed values referencing a separate probability table (e.g., as an 8-bit value referencing a 256 item probability lookup table).

In step 409, the follower list is reviewed again to determine if there are any other follower words that have not yet been stored in the structure 500. If there are additional words to be stored, then control is returned to step 405 so that the next set of follower words can be stored in a similar manner (i.e., class index, number of follower words in the class, word index, word index . . . ). It is clear from this example that the greater the number of follower words in the same class, the more that this compression process may reduce the required amount of storage for the structure 500. For example, the follower lists for word identifier 517 (word_id4) and 518 (word_id8) require approximately the same amount of dedicated space in the storage structure 500, even though the follower list for word identifier 517 includes seven words and the follower list for word identifier 518 includes only three words.

In step 410, the vocabulary is traversed to determine whether every word, along with its corresponding follower list, has been added to the structure 500. If there are additional words to be added, then control is returned to step 404 so that the word and follower list data can be added to the structure 500, as described above. When every word in the vocabulary has been added to the data structure 500 of the compressed language model, along with its follower list, the process is terminated at step 411.

Using the previously-discussed practical example, the storage requirements resulting from the compression techniques described in FIGS. 4 and 5 can be compared with the storage requirements of conventional techniques. Assume again that an N-gram language model developed for natural language dictation of spoken messages has a vocabulary of 38,900 words, and that 443,248 bigrams have been identified during the training process. Thus, each word in the storage structure 200 has an average follower list size of 11.4 words. In a typical POS class arrangement, it has been determined that each word may have an average of 3.5 different classes represented in its list of followers. In this example, the storage size for this data structure 500 may be determined by the following equation:

38900 words*3.5 class indexes/follower list*[1 byte/class index+1 byte for # of class words in follower list+(3.3 words/class*1 byte/word index)]=721,595 bytes

Thus, any device running the speech recognizer in this example must dedicate approximately 705 KB to storing this bigram language model. Comparing this example to the conventional structure 200 described above (which required 866 kilobytes of storage), the storage space required for the compressed N-gram model 500, which contains the same number of unigrams and bigrams as in the conventional example 200, may be reduced by approximately 19% using aspects of the present inventive techniques.

The compression techniques described with reference to FIGS. 4 and 5 may provide additional advantages when used with larger language models. As is known in the art, large language models may typically have longer average follower lists, thus increasing the occasions in which a longer word identifier can be substituted for a shorter word index, thereby reducing the size of the overall model. The inventive techniques disclosed herein are not just alternatives to the conventional methods for compressing N-gram language models, but may additionally be used in combination with other compression techniques to further reduce the storage requirements for N-gram models. For example, the memory size can be further reduced by using non-uniform length indexes (e.g., with Huffman coding), for deriving variable length bit indexes to represent words. In this example, shorter length indexes may be used to represent words frequently found in follower lists, while longer length indexes may be used to represent for less frequent words.

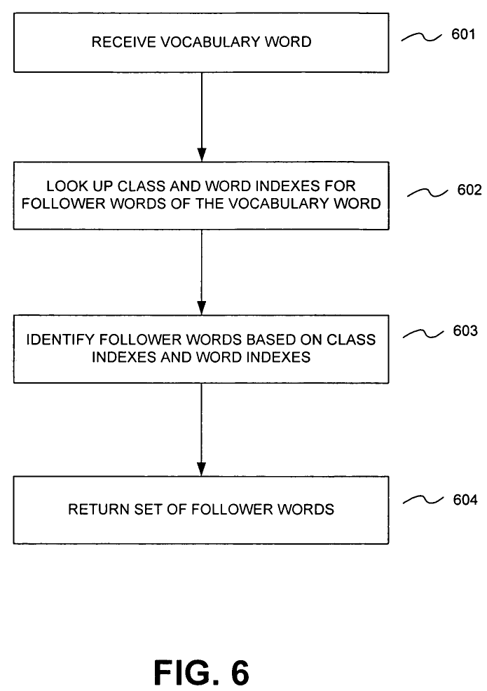

Referring now to FIG. 6, a flow diagram is shown illustrating the retrieval of a set of follower words in accordance with aspects of the present invention. In this example, a speech recognizer software application executing on an electronic device (e.g., computer or mobile terminal 301) receives as input a word in vocabulary of the language model in step 601. Typically, the input word may be received as part of a spoken word sequence input to the terminal 301 by a speaker. In step 602, the compressed N-gram model (e.g., storage structure 500) is searched to retrieve the set of class index values and associated word index values for the input word. For example, if the input word corresponded to word identifier 519 (word_id6), then the values retrieved in step 602 would consist of the following set [c_in1, w_in1, w_in7, w_in13, w_in18, c_in3, w_in4]. In step 603, the associated class indexes and word indexes are used to look up the follower words in the dictionary. Thus, in the above example, each of the following class index/word index pair corresponds to a unique word in the dictionary of the speech recognizer [c_in1/w_in1, c_in1/w_in7, c_in1/w_in13, c_in1/w_in18, c_in3/w_in4]. In step 604, the set of follower words is returned to the caller.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

1. A method for storing an N-gram model in a memory of a device, comprising:
identifying a plurality of word classes;
receiving a vocabulary of words, wherein each word in the vocabulary is associated with at least one of the plurality of classes;
associating a follower list with each word in the vocabulary;
storing in the memory information associated with a first word in the vocabulary, the information comprising:
(1) a first class index corresponding to a class in which at least a subset of the follower list is a member, and
(2) a first plurality of word indexes corresponding to at least a subset of the follower list for the first word, wherein said word indexes are indexed based on the first class index.

2. The method of claim 1, wherein one of the first plurality of word indexes does not uniquely identify a word in the vocabulary, but wherein the first class index combined with any of the first plurality of word indexes does uniquely identify a word in the vocabulary.

3. The method of claim 1, wherein the stored information associated with the first word further comprises:
(3) a first integer representing the number of word indexes in the first plurality.

4. The method of claim 3, wherein the stored information associated with the first word further comprises:
(4) a second class index corresponding to a class in which a different subset of the follower list is a member, and
(5) a second plurality of word indexes corresponding to a different subset of the follower list for the first word, wherein said word indexes are indexed based on the second class index;
(6) a second integer representing the number of word indexes in the second plurality.

5. The method of claim 1, wherein the plurality of word classes comprises no more than 256 different classes and the first class index is stored as an 8-bit index to a word class list, and wherein the maximum number of words associated with a single class does not exceed 256 and each of the first plurality of word indexes is stored as an 8-bit index to a list of words in the word class associated with the first class index.

6. The method of claim 1, wherein the words are words in a written or spoken language, and wherein the vocabulary consists of a set of words from the same language.

7. The method of claim 6, wherein the plurality of word classes is derived using at least one of a statistical clustering technique, syntactic word classifications, and semantic word classifications.

8. The method of claim 7, wherein the plurality of word classes are derived based on syntactic word classifications corresponding to parts of speech.

9. The method of claim 1, wherein each word in the vocabulary is associated with only one class.

10. An electronic device comprising:
a processor controlling at least some operations of the electronic device;
a memory storing computer executable instructions that, when executed by the processor, cause the electronic device to perform a method for storing an N-gram model, the method comprising:
identifying a plurality of word classes;
receiving a vocabulary of words, wherein each word in the vocabulary is associated with at least one of the plurality of classes;
associating a follower list with each word in the vocabulary;
storing in the memory information associated with a first word in the vocabulary, the information comprising:
(1) a first class index corresponding to a class in which at least a subset of the follower list is a member, and
(2) a first plurality of word indexes corresponding to at least a subset of the follower list for the first word, wherein said word indexes are indexed based on the first class index.

11. The electronic device of claim 10, wherein one of the first plurality of word indexes does not uniquely identify a word in the vocabulary, but wherein the first class index combined with any of the first plurality of word indexes does uniquely identify a word in the vocabulary.

12. The electronic device of claim 10, wherein the stored information associated with the first word further comprises:
(3) a first integer representing the number of word indexes in the first plurality.

13. The electronic device of claim 12, wherein the stored information associated with the first word further comprises:
(4) a second class index corresponding to a class in which a different subset of the follower list is a member, and
(5) a second plurality of word index corresponding to a different subset of the follower list for the first word, wherein said word index are indexed based on the second class index;
(6) a second integer representing the number of word indexes in the second plurality.

14. The electronic device of claim 10, wherein the plurality of word classes comprises no more than 256 different classes and the first class index is stored as an 8-bit index to a word class list, and wherein the maximum number of words associated with a single class does not exceed 256 and each of the first plurality of word index is stored as an 8-bit index to a list of words in the word class associated with the first class index.

15. The electronic device of claim 10, wherein the plurality of word classes is derived using at least one of a statistical clustering technique, syntactic word classifications, and semantic word classifications.

16. The electronic device of claim 15, wherein the plurality of word classes is derived based on syntactic word classifications corresponding to parts of speech.

17. The electronic device of claim 10, wherein each word in the vocabulary is associated with only one class.

18. One or more computer readable media storing computer-executable instructions which, when executed on a computer system, perform a method for storing an N-gram model in a memory of a device, the method comprising:
identifying a plurality of word classes;
receiving a vocabulary of words, wherein each word in the vocabulary is associated with at least one of the plurality of classes;
associating a follower list with each word in the vocabulary;
storing in the memory information associated with a first word in the vocabulary, the information comprising:
(1) a first class index corresponding to a class in which at least a subset of the follower list is a member, and
(2) a first plurality of word indexes corresponding to at least a subset of the follower list for the first word, wherein said word indexes are indexed based on the first class index.

19. The computer readable media of claim 18, wherein one of the first plurality of word indexes does not uniquely identify a word in the vocabulary, but wherein the first class index combined with any of the first plurality of word indexes does uniquely identify a word in the vocabulary.

20. The computer readable media of claim 18, wherein the stored information associated with the first word further comprises:
(3) a first integer equal to the number of word indexes in the first plurality.

21. The computer readable media of claim 20, wherein the stored information associated with the first word further comprises:
(4) a second class index corresponding to a class in which a different subset of the follower list is a member, and
(5) a second plurality of word indexes corresponding to a different subset of the follower list for the first word, wherein said word indexes are indexed based on the second class index;
(6) a second integer equal to the number of word indexes in the second plurality.

22. The computer readable media of claim 18, wherein the plurality of word classes comprises no more than 256 different classes and the first class index is stored as an 8-bit index to a word class list, and wherein the maximum number of words associated with a single class does not exceed 256 and each of the first plurality of word indexes is stored as an 8-bit index to a list of words in the word class associated with the first class index.

23. The computer readable media of claim 18, wherein the plurality of word classes is derived using at least one of a statistical clustering technique, syntactic word classifications, and semantic word classifications.

24. An electronic device comprising:
an input component for receiving input from a user of the electronic device;
a processor controlling at least some operations of the electronic device; and
a memory storing computer executable instructions that, when executed by the processor, cause the electronic device to perform a method for retrieving follower words from an N-gram model, said method comprising:
receiving an input corresponding to a sequence of words;
retrieving from the memory a first word identifier corresponding to a first word in the sequence of words;
retrieving from the memory a follower list associated with the first word, the follower list comprising a class index and a plurality of word indexes, wherein said word indexes are indexed based on the class index; and
retrieving from the memory a plurality of follower words corresponding to the combinations of the class index with the plurality of word indexes.

25. The electronic device of claim 24, further comprising a display screen, wherein the method further comprises displaying at least one of the plurality of retrieved follower words on the display screen.

26. The electronic device of claim 24, wherein the input component comprises a microphone, and wherein receiving the input comprises recording a message spoken from a user of the electronic device into the microphone.

27. The electronic device of claim 24, wherein the memory stores a dictionary of words, and wherein one of the plurality of word indexes does not uniquely identify a word in the dictionary but the class index combined with any of the plurality of word indexes does uniquely identify a word in the dictionary.

28. The electronic device of claim 25, wherein the method further comprises:
determining which of the plurality of retrieved follower words to display on the display screen based on a plurality of probabilities stored in said memory, wherein each combination of the class index and one of the plurality of word indexes is associated with a probability stored in said memory.

29. A method for retrieving follower words from an N-gram model in a memory of a device, comprising:
receiving an input corresponding to a sequence of words;
retrieving from the memory a first word identifier corresponding to a first word in the sequence of words;
retrieving from the memory a follower list associated with the first word, the follower list comprising a class index and a plurality of word indexes, wherein said word indexes are indexed based on the class index; and
retrieving from the memory a plurality of follower words corresponding to the combinations of the class index with the plurality of word indexes.

30. The method of claim 29, further comprising displaying at least one of the plurality of follower words on a display screen of the device.

31. The method of claim 29, wherein the device comprises a microphone, and wherein receiving the input comprises storing in the memory a message spoken from a user of the device into the microphone.

32. The method of claim 29, wherein the memory stores a dictionary of words, and wherein one of the plurality of word indexes does not uniquely identify a word in the dictionary but the class index combined with any of the plurality of word indexes does uniquely identify a word in the dictionary.

33. The method of claim 30, further comprising:
determining which of the plurality of retrieved follower words to display on the display screen based on a plurality of probabilities stored in said memory, wherein each combination of the class index and one of the plurality of word indexes is associated with a probability stored in said memory.

34. An electronic device comprising:
a storage means for storing an N-gram model of follower words;
an input means for receiving an input corresponding to a sequence of words;
means for retrieving from the storage means a first word identifier corresponding to a first word in the sequence of words;
means for retrieving from the storage means a follower list associated with the first word, the follower list comprising a class index and a plurality of word indexes, wherein said word indexes are indexed based on the class index; and
means for retrieving from the storage means a plurality of follower words corresponding to the combinations of the class index with the plurality of word indexes.

35. The electronic device of claim 34, further comprising:
a display means for displaying at least one of the plurality of follower words on a display screen based on a plurality of probabilities stored in said storage means, wherein each combination of the class index and one of the plurality of word indexes is associated with a probability stored in said storage means.
